(19) United States
(12) Patent Application Publication
(10) Pub. No.: US 2025/0048432 A1
(43) Pub. Date: Feb. 6, 2025

(54) METHOD AND APPARATUS FOR PERFORMING COMMUNICATION IN WIRELESS COMMUNICATION SYSTEM

(71) Applicant: LG Electronics Inc., Seoul (KR)

(72) Inventors: Eunjong LEE, Seoul (KR); Kyungho LEE, Seoul (KR); Bonghoe KIM, Seoul (KR); Sangrim LEE, Seoul (KR)

(21) Appl. No.: 18/714,794

(22) PCT Filed: Nov. 23, 2022
(86) PCT No.: PCT/KR2022/018624

§ 371 Date: May 30, 2024

(30) Foreign Application Priority Data
Nov. 30, 2021 (KR) 10-2021-0169081

(51) Int. Cl. H04W 74/0833; H04B 17/318; H04W 24/02

(52) U.S. Cl. CPC H04W 74/0833; H04B 17/328; H04W 24/02

(57) ABSTRACT

In the present disclosure, a method for operating a terminal in a wireless communication may include receiving, by the terminal, a synchronization signal from a base station, transmitting a random access preamble to the base station based on the synchronization signal, receiving a random access response based on the random access preamble, performing connection with the base station after receiving the random access response, receiving at least any one of AI/ML model information and model performance feedback-related information for an AI/ML model from the base station, and performing model inference in the AI/ML model based on the AI/ML model information and determining, through model performance evaluation, whether or not to transmit MPF of the AI/ML model to the base station.

### TECHNICAL FIELD

The present disclosure relates to a wireless communication system, and more particularly, to a method and device for performing communication in a wireless communication system. Especially, the present disclosure relates to a method and device for sharing an artificial intelligence (AI)/machine learning (ML) model.

### BACKGROUND ART

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

In particular, as a large number of communication devices require a large communication capacity, the enhanced mobile broadband (eMBB) communication technology, as compared to the conventional radio access technology (RAT), is being proposed. In addition, not only massive machine type communications (massive MTC), which provide a variety of services anytime and anywhere by connecting multiple devices and objects, but also a communication system considering a service/user equipment (UE) sensitive to reliability and latency is being proposed. Various technical configurations for this are being proposed.

### DISCLOSURE

### Technical Problem

The present disclosure relates to a method and device for performing communication in a wireless communication system.

The present disclosure relates to a method and device for sharing an AI/ML model in a wireless communication system.

The present disclosure relates to a method and device for reporting MPF on an AI/ML model to a base station in a wireless communication system.

The present disclosure relates to a method and device for obtaining MPF configuration-relates information for MPF report about an AI/ML model in a wireless communication system.

The present disclosure relates to a method and device for determining information included in MPF based on an AI/ML model in a wireless communication system.

Technical objects to be achieved in the present disclosure are not limited to what is mentioned above, and other technical objects not mentioned therein can be considered from the embodiments of the present disclosure to be described below by those skilled in the art to which a technical configuration of the present disclosure is applied.

### Technical Solution

As an example of the present disclosure, a method for operating a terminal in a wireless communication system may include receiving, by the terminal, a synchronization signal from a base station, transmitting a random access preamble to the base station based on the synchronization signal, receiving a random access response based on the random access preamble, performing connection with the base station after receiving the random access response, receiving at least any one of artificial intelligence (AI)/machine learning (ML) model information and model performance feedback (MPF)-related information for an AI/ML model from the base station, and performing model inference in the AI/ML model based on the AI/ML model information and determining, through model performance evaluation, whether or not to transmit MPF of the AI/ML model to the base station.

In addition, as an example of the present disclosure, a method for operating a base station in a wireless communication system may include transmitting a synchronization signal to a terminal, receiving a random access preamble from the terminal based on the synchronization signal, transmitting a random access response to the terminal based on the random access preamble, performing connection with the terminal after receiving the random access response, and transmitting at least any one of artificial intelligence (AI)/machine learning (ML) model information and model performance feedback (MPF)-related information for an AI/ML model to the terminal, and the terminal may perform model inference in the AI/ML model based on the AI/ML model information and determine, through model performance evaluation, whether or not to transmit MPF of the AI/ML model to the base station.

In addition, as an example, of the present disclosure, a terminal in a wireless communication system may include a transceiver and a processor coupled with the transceiver, and the processor may control the transceiver to receive a synchronization signal from a base station, control the transceiver to transmit a random access preamble to the base station based on the synchronization signal, control the transceiver to receive a random access response based on the random access preamble, perform connection with the base station after receiving the random access response, control the transceiver to receive at least any one of artificial intelligence (AI)/machine learning (ML) model information and model performance feedback (MPF)-related information for an AI/ML model from the base station, perform model inference in the AI/ML model based on the AI/ML model information, and determine, through model performance evaluation, whether or not to transmit MPF of the AI/ML model to the base station.

In addition, as an example of the present disclosure, a base station in a wireless communication system may include a transceiver and a processor coupled with the transceiver, and the processor may control the transceiver to transmit a synchronization signal to a terminal, control the transceiver to receive a random access preamble from the terminal based on the synchronization signal, control the transceiver to transmit a random access response to the terminal based on the random access preamble, perform connection with the terminal after receiving the random access response, and control the transceiver to transmit at least any one of artificial intelligence (AI)/machine learning (ML) model information and model performance feedback (MPF)-related information for an AI/ML model to the terminal, and the terminal may perform model inference in the AI/ML model based on the AI/ML model information and determine, through model performance evaluation, whether or not to transmit MPF of the AI/ML model to the base station.

In addition, as an example of the present disclosure, in a device including at least one memory and at least one processor functionally coupled with the at least one memory, the at least one processor may control the device to receive a synchronization signal from a base station, control the device to transmit a random access preamble to the base station based on the synchronization signal, control the device to receive a random access response based on the random access preamble, control the device to perform connection with the base station after receiving the random access response, control the device to receive at least any one of artificial intelligence (AI)/machine learning (ML) model information and model performance feedback (MPF)-related information for an AI/ML model from the base station, control the device to perform model inference in the AI/ML model based on the AI/ML model information, and control the device to determine, through model performance evaluation, whether or not to transmit MPF of the AI/ML model to the base station.

In addition, as an example of the present disclosure, a non-transitory computer-readable medium storing at least one instruction, the non-transitory computer-readable medium includes the at least one instruction that is executable by a processor, and the at least one instruction may be configured to receive a synchronization signal from a base station, to transmit a random access preamble to the base station based on the synchronization signal, to receive a random access response based on the random access preamble, to perform connection with the base station after receiving the random access response, to receive at least any one of artificial intelligence (AI)/machine learning (ML) model information and model performance feedback (MPF)-related information for an AI/ML model from the base station, to perform model inference in the AI/ML model based on the AI/ML model information, and to determine, through model performance evaluation, whether or not to transmit MPF of the AI/ML model to the base station.

In addition, the following may be commonly applied.

As an example of the present disclosure, MPF-related information may include at least any one of MPF parameter information of an AI/ML model. MPF triggering condition information, and MPF-related data information.

Herein, as an example of the present disclosure, a MPF parameter may be identically set in at least one or more AI/ML models.

In addition, as an example of the present disclosure, the MPF parameter information may include at least any one of prediction accuracy information of an AI/ML model, channel state information (CSI) feedback information, and information on measured values.

In addition, as an example of the present disclosure, in case beam prediction is performed based on an AI/ML model, a terminal may obtain beam quality prediction accuracy information included in MPF parameter information, the beam quality prediction accuracy information may include a preset beam quality prediction accuracy value for determining whether or not to transmit MPF to a base station, the terminal may perform RSRP prediction for at least one or more beams through model inference based on the AI/ML model, report a beam with a highest RSRP to the base station to change a beam, and determine whether or not to transmit MPF to the base station based on whether or not a comparison value between an actually measured RSRP for at least one or more bears and a RSRP prediction for the at least one or more beams is greater or equal to the beam quality prediction accuracy value.

In addition, as an example of the present disclosure. MPF triggering condition information may include at least any one of threshold information and transmission scheme information, the threshold information may include at least any one of a threshold for a feedback value and a threshold regarding update determination of an AI/ML model, the transmission scheme information may indicate an MPF transmission scheme of the AI/ML model, and MPF may be transmitted based on at least any one of periodic transmission, aperiodic transmission based on an event, and transmission on a model inference occasion.

In addition, as an example of the present disclosure, a terminal may perform an action based on an output for model inference of AI/ML model information and perform model performance evaluation based on the output and the action, and in case MPF of an AI/ML model is not to be transmitted based on the model performance evaluation, the terminal may perform an action by generating an output based on model inference of the AI/ML model, and in case the MPF of the AI/ML model is to be transmitted based on the model performance evaluation, the terminal may receive AI/ML model information, which is updated in a base station, and perform an action by generating an output based on an updated AI/ML model.

In addition, as an example of the present disclosure, whether or not to transmit MPF of an AI/ML model may be determined based on at least any one of an event set by a base station, an event set by a terminal, and a preset event.

In addition, as an example of the present disclosure, in case transmission of MPF is determined, the MPF may include at least any one of 1-bit indication information indicating a performance status of each AI/ML model, a model performance evaluation result value of an AI/ML model, and a data value related to model performance evaluation.

In addition, as an example of the present disclosure, in case MPF includes 1-bit indication information indicating a performance status of each AI/ML model, the 1-bit indication information indicating the performance status of each AI/ML model may be determined based on comparison between a model performance evaluation result value based on model inference and a threshold and be included in the MPF.

In addition, as an example of the present disclosure, in case MPF includes a model performance evaluation result value of each AI/ML model, the MPF may include at least any one of the model performance evaluation result value and a difference value between the model performance evaluation result value and a preset value.

In addition, as an example of the present disclosure, in case MPF of an AI/ML model is determined to be transmitted to a base station, the MPF may be indicated through at least any one of a physical uplink control channel (PUCCH) and a physical uplink shared channel (PUSCH).

In addition, as an example of the present disclosure, in case MPF of an AI/ML model is determined to be transmitted to a base station, the MPF may be transmitted by being included in a medium access control (MAC) control element (CE).

In addition, as an example of the present disclosure, in case MPF of an AI/ML model is determined to be transmitted to a base station, the MPF may be transmitted through an uplink-dedicated control channel based on a radio resource control (RRC) message.

### Advantageous Effects

As is apparent from the above description, the embodiments of the present disclosure have the following effects.

The embodiments of the present disclosure may provide a method for performing communication.

The embodiments of the present disclosure may provide a method for sharing an AI/ML model.

The embodiments of the present disclosure may provide a method for reporting MPF on an AI/ML model to a base station.

The embodiments of the present disclosure may provide a method for obtaining information on an MPF configuration for MPF report about an AI/ML model.

The embodiments of the present disclosure may provide a method for determining information included in MPF based on an AI/ML model.

Effects obtained in the present disclosure are not limited to the above-mentioned effects, and other effects not mentioned above may be clearly derived and understood by those skilled in the art, to which a technical configuration of the present disclosure is applied, from the following description of embodiments of the present disclosure.

That is, effects, which are not intended when implementing a configuration described in the present disclosure, may also be derived by those skilled in the art from the embodiments of the present disclosure.

### DESCRIPTION OF DRAWINGS

The accompanying drawings are provided to aid understanding of the present disclosure, and embodiments of the present disclosure may be provided together with a detailed description. However, the technical features of the present disclosure are not limited to a specific drawing, and features disclosed in each drawing may be combined with each other to constitute a new embodiment. Reference numerals in each drawing may mean structural elements.

FIG. 1 is a view illustrating an example of a communication system applicable to the present disclosure.

FIG. 2 is a view illustrating an example of a wireless apparatus applicable to the present disclosure.

FIG. 3 is a view illustrating another example of a wireless device applicable to the present disclosure.

FIG. 4 is a diagram illustrating an example of an AI device applied to the present disclosure.

FIG. 5 is a view illustrating a functional framework according to an embodiment of the present disclosure.

FIG. 6 is a view illustrating a method of generating an AI/ML-based model inference output according to an embodiment of the present disclosure.

FIG. 7 is a view illustrating a method of generating an AI/ML-based model inference output according to an embodiment of the present disclosure.

FIG. 8 is a view illustrating a case where both model training and model inference exist in a RAN, according to an embodiment of the present disclosure.

FIG. 9 is a view illustrating a method of performing AI/ML-based model training in a network and model inference in a terminal, according to an embodiment of the present disclosure.

FIG. 10 is a view illustrating a method of performing AI/ML-based model training in a network and model inference in a network and a terminal, according to an embodiment of the present disclosure.

FIG. 11 is a view illustrating a method for performing MPF transmission applicable to the present disclosure.

FIG. 12 may be a MAC CE format in which information included in MPF applicable to the present disclosure is transmitted.

FIG. 13 is a view illustrating an operation of a terminal that is applicable to the present disclosure.

FIG. 14 is a view illustrating an operation of a terminal based on beam prediction that is applicable to the present disclosure.

FIG. 15 is a flowchart illustrating an operation of a terminal that is applicable to the present disclosure.

FIG. 16 is a flowchart illustrating an operation of a terminal that is applicable to the present disclosure.

### MODE FOR INVENTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 38.211, 3GPP TS 38.212, 3GPP TS 38.213, 3GPP TS 38.321 and 3GPP TS 38.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.XXX Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.XXX

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

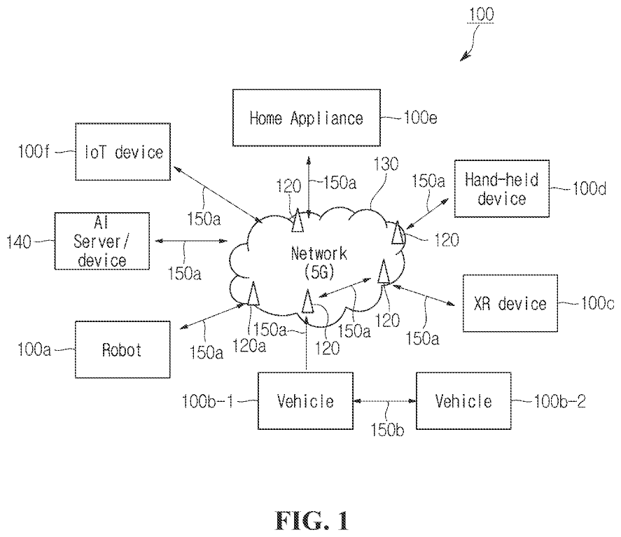

FIG. 1 is a view illustrating an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone) The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

### Communication System Applicable to the Present Disclosure

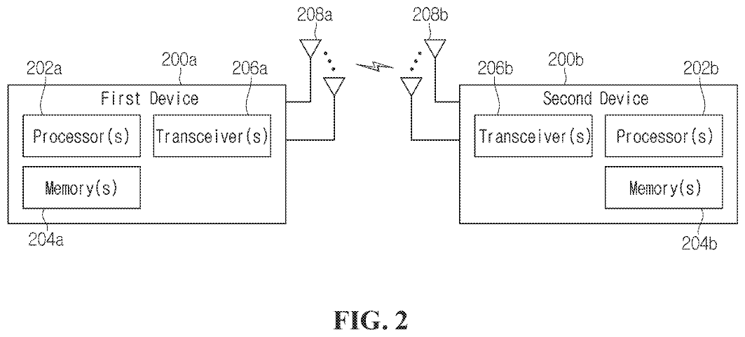

FIG. 2 is a view illustrating an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional lavers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

### Structure of Wireless Device Applicable to the Present Disclosure

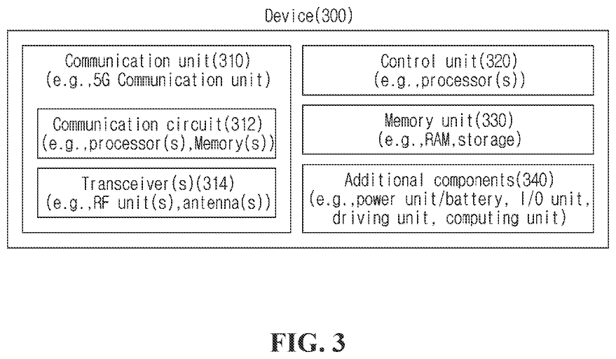

FIG. 3 is a view illustrating another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

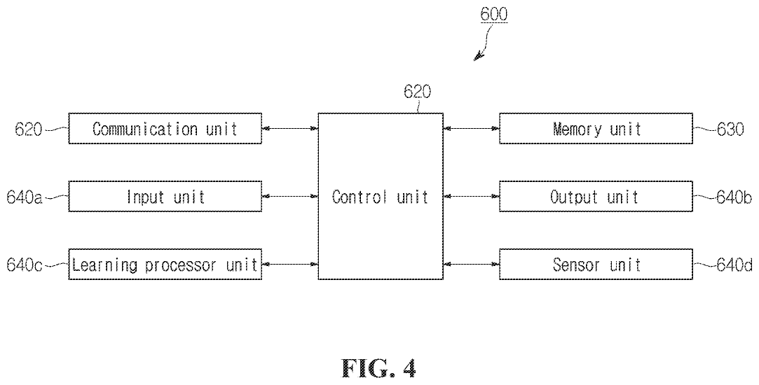

FIG. 4 is a diagram illustrating an example of an AI device applied to the present disclosure. For example, the AI device may be implemented as a fixed device or a movable device such as TV, projector, smartphone, PC, laptop, digital broadcasting terminal, tablet PC, wearable device, set-top box (STB), radio, washing machine, refrigerator, digital signage, robot, vehicle, etc.

Referring to FIG. 4, the AI device 600 may include a communication unit 610, a control unit 620, a memory unit 630, an input/output unit 640a/640b, a learning processor unit 640c and a sensor unit 640d. Blocks 610 to 630/640A to 640D may correspond to blocks 310 to 330/340 of FIG. 3, respectively.

The communication unit 610 may transmit and receive a wired and wireless signal (e.g., sensor information, user input, learning model, control signal, etc.) to and from external devices such as another AI device (e.g., 100x, 120, 140 in FIG. 1) or an AI server (140 in FIG. 1) using wired/wireless communication technology. To this end, the communication unit 610 may transmit information in the memory unit 630 to an external device or send a signal received from an external device to the memory unit 630.

The control unit 620 may determine at least one executable operation of the AI device 600 based on information determined or generated using a data analysis algorithm or machine learning algorithm. In addition, the control unit 620 may control the components of the AI device 600 to perform the determined operation. For example, the control unit 620 may request, search, receive, or utilize the data of the learning processor 640c or the memory unit 630, and control the components of the AI device 600 to perform predicted operation or operation determined to be preferred among at least one executable operation. In addition, the control unit 620 collects history information including a user's feedback on the operation content or operation of the AI device 600, and stores it in the memory unit 630 or the learning processor 640c or transmit it to an external device such as the AI server (140 in FIG. 1). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensor unit 640. Also, the memory unit 630 may store control information and/or software code required for operation/execution of the control unit 620.

The input unit 640a may obtain various types of data from the outside of the AI device 600. For example, the input unit 620 may obtain learning data for model learning, input data to which the learning model is applied, etc. The input unit 640a may include a camera, a microphone and/or a user input unit, etc. The output unit 640b may generate audio, video or tactile output. The output unit 640b may include a display unit, a speaker and/or a haptic module. The sensor unit 640 may obtain at least one of internal information of the AI device 600, surrounding environment information of the AI device 600 or user information using various sensors. The sensor unit 640 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, and/or a radar.

The learning processor unit 640c may train a model composed of an artificial neural network using learning data. The learning processor unit 640c may perform AI processing together with the learning processor unit of the AI server (140 in FIG. 1). The learning processor unit 640c may process information received from an external device through the communication unit 610 and/or information stored in the memory unit 630. In addition, the output value of the learning processor unit 640c may be transmitted to an external device through the communication unit 610 and/or stored in the memory unit 630.

### 6G Communication System

A 6G (wireless communication) system has purposes such as (i) very high data rate per device. (ii) a very large number of connected devices. (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

### Artificial Intelligence (AI)

The most important and newly introduced technology for the 6G system is AI. AI was not involved in the 4G system. 5G systems will support partial or very limited AI. However, the 6G system will support AI for full automation. Advances in machine learning will create more intelligent networks for real-time communication in 6G. Introducing AI in communication may simplify and enhance real-time data transmission. AI may use a number of analytics to determine how complex target tasks are performed. In other words, AI may increase efficiency and reduce processing delay.

Time consuming tasks such as handover, network selection, and resource scheduling may be performed instantly by using AI. AI may also play an important role in machine-to-machine, machine-to-human and human-to-machine communication. In addition, AI may be a rapid communication in a brain computer interface (BCI). AI-based communication systems may be supported by metamaterials, intelligent structures, intelligent networks, intelligent devices, intelligent cognitive radios, self-sustained wireless networks, and machine learning.

Recently, attempts have been made to integrate AI with wireless communication systems, but application layers, network layers, and in particular, deep learning have been focused on the field of wireless resource management and allocation. However, such research is gradually developing into the MAC layer and the physical layer, and in particular, attempts to combine deep learning with wireless transmission are appearing in the physical layer. AI-based physical layer transmission means applying a signal processing and communication mechanism based on an AI driver rather than a traditional communication framework in fundamental signal processing and communication mechanisms. For example, deep learning-based channel coding and decoding, deep learning-based signal estimation and detection, deep learning-based multiple input multiple output (MIMO) mechanism, and AI-based resource scheduling and allocation may be included.

Machine learning may be used for channel estimation and channel tracking, and may be used for power allocation, interference cancellation, and the like in a downlink (DL) physical layer. Machine learning may also be used for antenna selection, power control, symbol detection, and the like in a MIMO system.

However, the application of DNN for transmission in the physical layer may have the following problems.

Deep learning-based AI algorithms require a lot of training data to optimize training parameters. However, due to limitations in obtaining data in a specific channel environment as training data, a lot of training data is used offline. This is because static training on training data in a specific channel environment may cause a contradiction between diversity and dynamic characteristics of a radio channel.

In addition, current deep learning mainly targets real signals. However, the signals of the physical layer of wireless communication are complex signals. In order to match the characteristics of a wireless communication signal, additional research on a neural network that detects a complex domain signal is required.

Hereinafter, machine learning will be described in greater detail.

Machine learning refers to a series of operations for training a machine to create a machine capable of performing a task which can be performed or is difficult to be performed by a person. Machine learning requires data and a learning model. In machine learning, data learning methods may be largely classified into three types: supervised learning, unsupervised learning, and reinforcement learning.

Neural network learning is to minimize errors in output. Neural network learning is a process of updating the weight of each node in the neural network by repeatedly inputting learning data to a neural network, calculating the output of the neural network for the learning data and the error of the target, and backpropagating the error of the neural network from the output layer of the neural network to the input layer in a direction to reduce the error.

Supervised learning uses learning data labeled with correct answers in the learning data, and unsupervised learning may not have correct answers labeled with the learning data. That is, for example, learning data in the case of supervised learning related to data classification may be data in which each learning data is labeled with a category. Labeled learning data is input to the neural network, and an error may be calculated by comparing the output (category) of the neural network and the label of the learning data. The calculated error is backpropagated in a reverse direction (i.e., from the output layer to the input layer) in the neural network, and the connection weight of each node of each layer of the neural network may be updated according to backpropagation. The amount of change in the connection weight of each updated node may be determined according to a learning rate. The neural network's computation of input data and backpropagation of errors may constitute a learning cycle (epoch). The learning rate may be applied differently according to the number of iterations of the learning cycle of the neural network. For example, in the early stages of neural network learning, a high learning rate is used to allow the neural network to quickly achieve a certain level of performance to increase efficiency, and in the late stage of learning, a low learning rate may be used to increase accuracy.

A learning method may vary according to characteristics of data. For example, when the purpose is to accurately predict data transmitted from a transmitter in a communication system by a receiver, it is preferable to perform learning using supervised learning rather than unsupervised learning or reinforcement learning.

The learning model corresponds to the human brain, and although the most basic linear model may be considered, a paradigm of machine learning that uses a neural network structure with high complexity such as artificial neural networks as a learning model is referred to as deep learning.

The neural network cord used in the learning method is largely classified into deep neural networks (DNN), convolutional deep neural networks (CNN), and recurrent Boltzmann machine (RNN), and this learning model may be applied.

Hereinafter will be described a method for configuring a functional framework based on an AI/ML model.

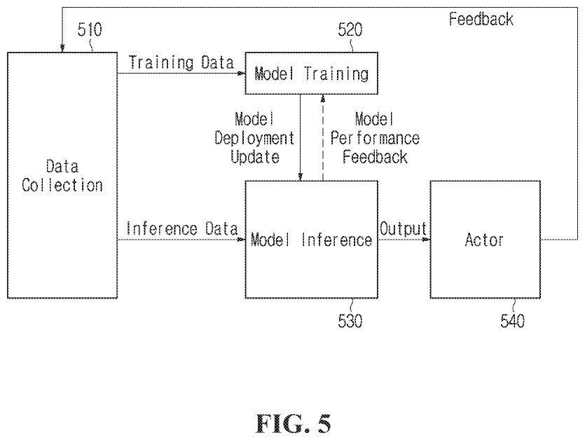

FIG. 5 is a view illustrating a functional framework. Communication may be performed based on AI.ML-enabled RAN intelligence. As an example, an AI/ML algorithm may be configured in various forms. Referring to FIG. 5, based on an AI/ML model that is preconfigured according to an AI/ML algorithm, an AI/ML-based operation may be performed according to AI/ML functionality and corresponding inputs and outputs.

Specifically, a data collection entity 510 may provide input data to a model training entity 540 and a model inference entity 520.

The input data may include at least any one of a measured value from another network entity, a feedback value from terminals, and a feedback value for an output of the AI/ML model. Training data, which the data collection entity 510 provides to the model training entity 540, may be data that is provided for an AI/ML model training function. In addition, inference data, which the data collection entity 510 provides to the model inference entity 520, may be data that is provided for an AI/ML model inference function. Herein, the model training entity 540 may be an entity that performs training, validation and testing of an AI/ML model.

The model training entity 540 may provide an AI/ML model to the model inference entity 520 and update the AI/ML model. In addition, the model inference entity 520 may provide model performance feedback to the model training entity 540. That is, the model training entity 540 may perform training for the AI/ML model through the feedback of the model inference entity 520 and provide the updated AI/ML model to the model inference entity 520 again. In addition, the model inference entity 520 may receive inference data from the model collection entity 510. Herein, the model inference entity 520 may generate an output through the provided AI/ML model and provide the output to an actor entity 530. Herein, the actor entity 530 may be an agent that performs an operation according to the output, and feedback on the operation performed by the actor entity 530 may be given to the data collection entity 510 again. In addition, the feedback information may be provided in turn to the model training entity 540 as training data.

That is, as data for training for an AI/ML model is provided, the AI/ML model may be trained and constructed, and as inference data is provided to the AI/ML model and is output, an operation based on the AI/ML model may be performed.

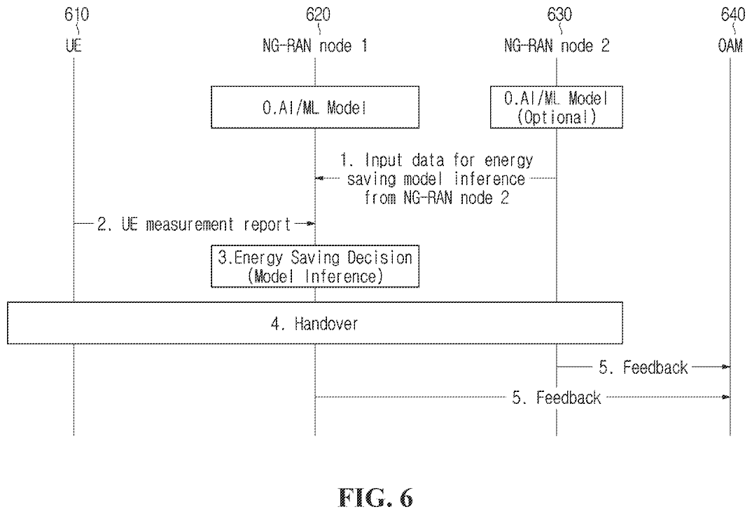

As a concrete example, FIG. 6 is a view illustrating a method of generating an AI/ML-based model inference output applicable to the present disclosure. Referring to FIG. 6, an NG-RAN node 1 620 may have an AI/ML model. Herein, a model inference of FIG. 5 may exist in the NG-RAN node 1 620, and training may be performed in OAM 640. That is, training for the AI/ML model may not performed in the RAN node, and the RAN node may have only the model inference. Herein, the NG-RAN node 1 620 may receive data for AI/ML model inference as required input data based on network energy saving from an NG-RAN node 2 630. As an example, the NG-RAN node 2 630 may have a model inference for the AI/ML model, which may not be necessary. Then, the NG-RAN node 1 620 may obtain measurement information from a terminal 610. The NG-RAN node 1 620 may generate an output for the model inference based on the measurement data obtained from the terminal 610 and the data obtained from the NG-RAN node 2 630. As an example, the output for the model inference may be an energy saving strategy or a handover strategy. That is, the NG-RAN node 1 620 may perform a handover for the terminal or other operations based on the model inference output but is not limited to a specific embodiment. Then, at least any one of the NG-RAN node 1 620 and the NG-RAN node 2 630 may deliver feedback to the OAM 640, and training may be performed in the OAM 640 based on the feedback.

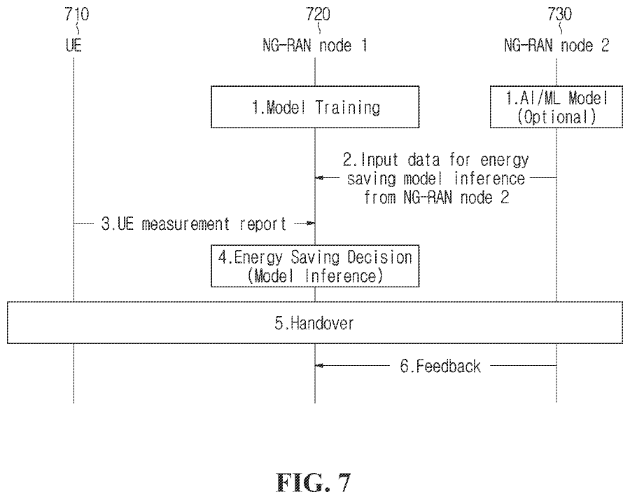

In addition. FIG. 7 is a view illustrating a method of generating an AI/ML-based model inference output applicable to the present disclosure. Referring to FIG. 7, unlike FIG. 6, an NG-RAN node 1 720 may perform model training on its own. Specifically, the NG-RAN node 1 720 may receive data for an AI/ML model inference as required input data from another NG-RAN node 2 730 based on network energy saving. As an example, the NG-RAN 2 730 may also have a model inference for an AI/ML model, which may not be necessary. Then, the NG-RAN node 1 720 may obtain measurement information from a terminal 710. The NG-RAN node 1 720 may generate an output for the model inference based on the measurement data obtained from the terminal 710 and the data obtained from the NG-RAN 2 730. As an example, the output for the model inference may be an energy saving strategy or a handover strategy. That is, the NG-RAN node 1 7620 may perform a handover for the terminal or other operations based on the model inference output but is not limited to a specific embodiment. Then, the NG-RAN node 1 720 may perform training on its own because the NG-RAN node 1 720 has model training. To this end, the NG-RAN node 1 720 may obtain feedback information from the NG-RAN node 2 730 and perform training on its own through the feedback information.

Herein, as an example, for AI/ML-based optimized network energy saving, an NG-RAN may need input data for AI/ML-based network energy saving. As an example, the input data may include at least any one of a current or expected resource status of a cell and a neighbor node, current or expected energy information of the cell and the neighbor node, and a terminal measurement report (eg. UE RSRP, RSRQ, SINR measurement, etc.).

In addition, in case a gNB needs an existing terminal measurement for AI/ML-based network energy saving, a RAN may reuse an existing framework (including MDT and RRM measurements) and is not limited to a specific embodiment.

In addition, as an example, output information for AI/ML-based network energy saving may include at least any one of an energy saving strategy, a handover strategy including a recommended candidate cell for traffic takeover, and predicted energy information, but is not limited thereto.

In addition, as an example, performance of a model may be optimized for AI/ML-based network energy saving. To this end, a RAN node may obtain at least any one of load measurement information and energy information but may not be limited thereto.

In addition, as an example, an AI/ML model may be considered for load balancing. Specifically, rapid traffic growth and multiple frequency bands utilized in a commercial network make it challenging to steer traffic distribution, and an AI/ML model may be considered for load balancing Load balancing may be to evenly distribute loads among cells or among cell areas, transfer part of traffic from congested cells or congested areas of cells, or perform offloading actions.

Herein, the load balancing may be performed through optimization of handover parameters and handover actions. However, the traffic load and resource status of the network may cause degradation of service quality in case that a plurality of high-mobility terminals are connected. Accordingly, it may be difficult to guarantee the overall network and service performance when performing load balancing, and in this regard, application of an AI/ML model may be considered.

As an example, when AI/ML-based load balancing is supported, model training may be located in OAM, and model inference may exist in a base station. As another example, both model training and model inference may exist in a base station. Herein, as an example, in a base station based on central unit (CU)-distributed unit (DU) architecture, model training may exist in OAM, and model inference may exist in a gNB-CU. As another example, both model training and model inference may exist in the gNB-CU. As another example, model training and model inference may exist in various locations and are not limited to a specific embodiment.

As an example, in order to improve a load balancing decision in a gNB (gNB-CU), the gNB may request a load prediction to a neighbor node. For AI/ML-based load balancing, if an existing terminal measurement is needed in a gNB, a RAN may reuse an existing framework (including MDT and RRM measurements) but may not be limited thereto.

As another example, an AI/ML model may be considered for mobility optimization. Mobility management may be a scheme to guarantee service-continuity during mobility by minimizing call drops, RLFs, unnecessary handovers, and ping-pong. For a high-frequency network, as the coverage of a single node decreases, the frequency for a terminal to handover between nodes may become higher. Especially for a high-mobility terminal, the handover frequency is more likely to become higher. Herein, for an application characterized with the stringent QoS requirements such as reliability, latency etc., the QoE is sensitive to handover performance, so that mobility management needs to avoid unsuccessful handover and to reduce latency during a handover procedure, and in this regard, an AI/ML model may be considered. As an example, by using AI/ML, at least any one of reduction of probability of unintended events, terminal location/mobility/performance prediction, and traffic steering may be performed. Herein, as an example, the unintended events may be too late handover, too early handover, and handover of a terminal to another cell in an intra system, but may not be limited thereto.

In addition, as an example, the terminal location/mobility/performance prediction may be performed by determining a best mobility target for maximization of efficiency and performance. The traffic steering may mean adjusting a handover trigger point based on efficient resource handling and selecting an optimal combination of cells to serve user.

That is, an AI/ML model may be needed in consideration of the above-described operation. Herein, it is possible to consider a case where based on the AI/ML model, model training is deployed in OAM and model inference exists in a RAN, which may be the same as the above-described FIG. 6. In addition, as an example, based on the AI/ML model, both model training and model inference may exist in a RAN, which may be the same as FIG. 7. As another example, in a CU-DU split scenario, model training may be located in CU-CP or OAM, and model inference may be located in CU-CP, but may not limited thereto.

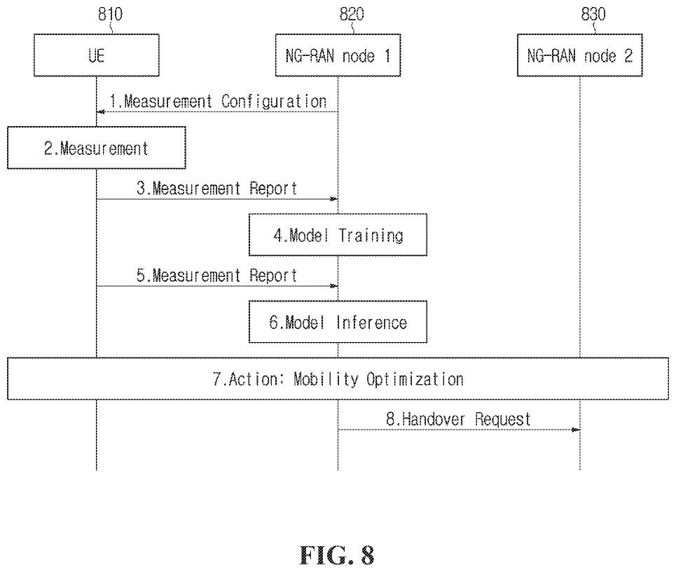

In addition, as an example, FIG. 8 is a view illustrating a case where both model training and model inference, which are applicable to the present disclosure, exist in a RAN. Referring to FIG. 8, an NG-RAN node 1 820 may have both model training and model inference. Herein, the NG-RAN node 1 820 may provide measurement configuration information to a terminal 810, and the terminal 810 may perform measurement based on the measurement configuration information and deliver a measurement report to the NG-RAN node 1 820. Then, the NG-RAN node 1 820 may perform model training. As another example, the NG-RAN node 1 820 may perform model inference based on the measurement report received from the terminal 810 and thus derive an output. Herein, as described above, the output may be an operation for load balancing or mobility optimization. As an example, based on a model inference output, the NG-RAN node 1 820 may request handover to the NG-RAN node 2 830 or request other operations to be performed but is not limited to a specific embodiment.

Based on what is described above, an AI/ML-based operation may be performed in a new communication system (e.g. 6G). As an example, the AI/ML technology may be applied not only to network technology but also to CSI feedback enhancement, beam management, positioning. RS overhead reduction, and RRM mobility enhancement, but may not be limited to a specific field. As an example, AI/ML may be applied to enhancing the technical field of PHY layers and MAC/RRC layers between a terminal and a base station, and a method for this will be described below.

Herein, as an example scenarios for enhancement in an air interface such as RAN1/RAN2 may be shown in Table 2 below. Specifically, it is possible to consider a scenario (case 1) where performance is enhanced by implementing an AI/ML model in at least one of a network and a terminal, a scenario (case 2) where performance is enhanced by implementing an AI/ML model independently in at least one of a network and a terminal and defining input/output, and a scenario (case 3) where performance is enhanced by sharing an AI/ML model that is implemented in a network or a terminal. Herein, as an example, hereinafter will be described a method of performing model training and model inference based on the scenario of case 3 that enhances performance by sharing an AI/ML model implemented in a network or a terminal. Specifically, the scenario may be a scenario where model training is performed in a network and model inference is performed in a terminal or both in the terminal and in a network at once, but may not be limited thereto.

TABLE 2
Case 1: performance enhancement through implementation of an AI/ML
model in NW and/or terminal
Case 2: performance enhancement through definition of input/output
and independent implementation of an AI/ML mode in NW and/or
terminal
Case 3: performance enhancement through sharing of an AI/ML model
implemented in NW or terminal

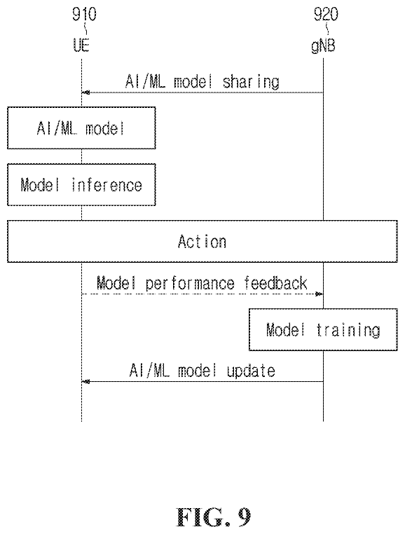

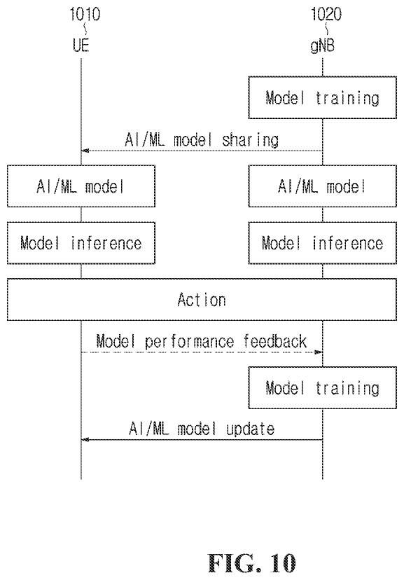

Herein, FIG. 9 is a view illustrating a method of performing AI/ML-based model training, which is applicable to the present disclosure, in a network and model inference in a terminal. In addition, FIG. 10 is a view illustrating a method of performing AI/ML-based model training, which is applicable to the present disclosure, in a network and model inference in a network and a terminal.

Referring to FIG. 9, to use an AI/ML model that is capable of being trained through cell information, a network may collect various information from terminals. Based on the information collected from the terminals, the network may deploy a model that has finished primary training, validation and testing through offline learning. The network needs to share the deployed AI/ML model with terminals within a cell. As an example, the network may share the deployed AI/ML model with the terminals within the cell through synchronization and thus enable the terminals to operate through the same model. Herein, when the model needs to be updated through model performance feedback or additional information (e.g. UE behavior such as RLF, BFR, etc.), the network may update the model and then share the updated AI/ML model with the terminals again. As an example, the model update may also include online learning at the network side. A terminal having capability for AI/ML within a cell may perform communication based on a received AI/ML model and thus perform enhanced communication.

Referring to FIG. 9, a base station 920 may share information on an AI/ML model, which is deployed based on model training, with a terminal 910. Herein, the terminal 910 may derive an output through model inference of the shared AI/ML model and perform an action corresponding thereto, which is the same as described above. Then, the terminal 910 may provide feedback on model performance to the base station 920, and the base station 920 may share the AI/ML model, which is updated after model training based on the feedback information, with the terminal 910.

In addition, referring to FIG. 10, the base station 1020 may share information on an AI/ML model, which is deployed based on model training, with a terminal 1010. Herein, the terminal 1010 may derive an output through model inference of the shared AI/ML model. In addition, the base station 1020 may also derive an output through model inference of the same AI/ML model. Then, the terminal 1010 and the base station 1020 may perform an action based on the outputs for model inference, which is the same as described above. Then, the terminal 1010 may provide feedback on model performance to the base station 1020, and the base station 1020 may share the AI/ML model, which is updated after model training based on the feedback information, with the terminal 1010.

Referring to FIG. 9 and FIG. 10 described above, a terminal needs to receive AI/ML model information. The terminal needs to obtain cell-specific AI/ML model information from a network and needs a method for obtaining the cell-specific AI/ML model information. Herein, the terminal may obtain the AI/ML model information through a system information block (SIB) that is broadcast by a base station. However, when AI/ML model information is broadcast through an SIB, every AI/ML model information needs to be included in a broadcast message. Accordingly, as the number of AI/ML model information to be transmitted increases, a terminal may be subject to more reception burden.

As another example, a base station may provide AI/ML model information to a terminal, which requests the AI/ML model information, through a unicast message. In case a unicast message is used to share an AI/ML model, the number of the unicast message may increase along with increase in the number of terminals. Accordingly, signaling overhead and resource consumption may increase. Accordingly, a method for efficiently sharing AI/ML model information by a base station with a terminal may be needed, which will be described below.

As describe above, a plurality of AI/ML models may be trained at a network side, and a terminal may perform model inference. Herein, for model training, the terminal needs to a performance evaluation value (model performance feedback (MPF)) for a corresponding AI/ML model to a base station, and a method of transmitting MPF and information included in the MPF will be described below. Specifically, a terminal may transmit MPF according to a specific event, instead of transmitting MPF on every occasion of model inference, thereby reducing unnecessary transmission of MPF, which will be described below.

In addition, as an example, a terminal may receive information on an AI/ML model, which is trained in a network, and also configuration information for relevant MPF. Herein, the configuration information for the MPF may be as shown in Table 3 below.

Specifically, configuration information for MPF may include a parameter for MPF according to each AI/ML model or of an AI/ML model according to each AI/ML model group. As an example, a parameter for MPF may be identically set according to each AI/ML model or each AI/ML model group. As another example, one or more parameter for MPF may be set for each AI/ML model or each AI/ML model group.

In addition, configuration information for MPF may include trigger condition information for AI/ML model performance feedback. Herein, the trigger condition information for the AI/ML model performance feedback may be a threshold for a feedback value and be set to a value that affects determination of model update, but is not limited to a specific embodiment. In addition, the trigger condition information for the AI/ML model performance feedback may be information on a transmission scheme. As an example, MPF may be periodically transmitted. As another example, MPF may be configured to be transmitted every time model inference is performed. As another example, MPF may be configured to be transmitted nonperiodically based on a specific event. Herein, configuration information for MPF transmission may be set for each AI/ML model or each AI/ML model group.

As another example, configuration information for MPF may be data information affecting the MPF. As a concrete example, in case of a beam prediction or CSI prediction, data information affecting MPF may include at least any one of information on a beam (CSI-RS/SSB quality) and information on CSI (e.g., CQI, PMI, RI). That is, data information affecting MPF may mean a parameter necessary for calculating the MPF and may all be included in function information for the MPF but is not limited to a specific embodiment.

TABLE 3
AI/ML model performance feedback parameter per model or model group;
Model performance feedback Trigger condition
Data information affecting MPF

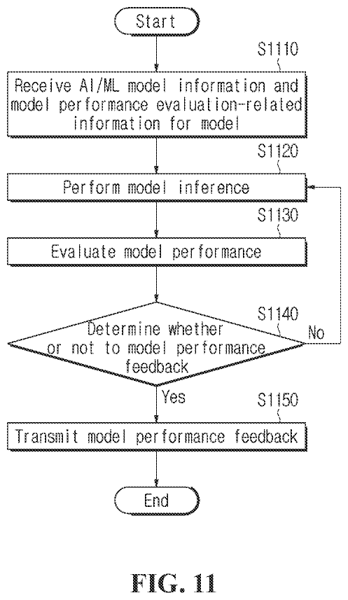

FIG. 11 is a view illustrating a method for performing MPF transmission applicable to the present disclosure. Referring to FIG. 11, a terminal may receive at least any one of information on an AI/ML model, which is completely trained, and model performance evaluation-related information for the AI/ML model from a base station (S1110). As an example, the terminal may receive the information on the AI/ML model and then the model performance evaluation-related information for the AI/ML model. As another example, the terminal may receive the model performance evaluation-related information together with the AI/ML model but is not limited to a specific embodiment. Based on the information on the AI/ML model received from the base station, the terminal may model information in the AI/ML model (S1120). In addition, after the model inference, the terminal may perform evaluation on model performance (S1130). As an example, whenever performing the model inference, the terminal may perform model performance evaluation using a configured model performance evaluation parameter. That is, the terminal may generate a model performance feedback (MPF) value based on the model inference. Herein, the terminal may determine whether or not to transmit derived MPF to the base station (S1140). As an example, MPF transmission may be at least any one of periodical transmission, aperiodic transmission based on an event, and transmission on an occasion of generating MPF, but is not limited to a specific embodiment. In case the terminal determines transmission of the MPF to the base station, the terminal may transmit the MPF to the base station (S1150).

Herein, as an example, whether or not to transmit the MPF may be determined based on information configured by the base station. As another example, whether or not to transmit the MPF may be determined based on an event that is determined in the terminal. As another example, whether or not to transmit the MPF may be determined based on a preset method, as shown in Table 4 below. However, the present disclosure may not be limited thereto.

TABLE 4
Determine according to event definition configured by a base station
Determine according to internal implementation of a terminal
Determine according to definition described in specifications

Based on what is described above, a terminal may transmit MPF to a base station. Herein, an element for determining whether or not to transmit MPF may be set to a value affecting determination that performance update of a model is necessary at the base station side, but may not be limited thereto. In addition, as an example, information included in MPF may be as shown in Table 5 below but is not limited thereto.

TABLE 5
Indicator information indicating that a model performance evaluation
result value is worse than a reference point (a specific value set
by NW or UE)
Model performance evaluation result value
Value for data affecting model performance evaluation

Specifically, MPF, which a terminal transmits to a base station, may include indicator information indicating whether or not a model performance evaluation result value is worse than a preset value. Specifically, a preset value based on a network or a terminal may be set as a threshold. Indicator information, which indicates whether a model performance evaluation result value is better or worse than a threshold, may be indicated. Herein, the indicator information may be configured as 1-bit information per AI/ML model (or AI/ML model group). 1-bit information may define a resource or field per AI/ML model and be indicated through a bit of a fixed resource or field. As an example, in case 1-bit indication information is a first value (or ON/true), a base station may perceive that performance of a corresponding AI/ML model is lower than a specific reference point (or threshold). Through what is described above, based on model performance evaluation, whether or not model performance is good may be indicated to a network by using a minimum amount of information instead of a model performance evaluation result value. Herein, the network may perform AI/ML model update by newly performing AI/ML model training based on data related to the AI/ML model and share the updated AI/ML model with terminals.

As another example, MPF may include a model performance evaluation value. That is, MPF may wholly include a model performance evaluation value. As another example, a model performance evaluation value may be transmitted as a difference value in comparison with a preset value (or threshold), and thus transmission capacity may be reduced. As an example, based on what is described above, the model performance evaluation value may be expressed by specific bit (e.g., n bits)-sized information, and information on a resource or field, which is fixed through resource or field definition per AI/ML model, may be transmitted to a base station. The base station may receive a performance result value of a corresponding AI/ML model and perceive that performance of the corresponding AI/ML model has been degraded. That is, a network may obtain an accurate model performance result value and determine, based on the model performance result value, whether or not new training is needed for an AI/ML model.

As an example, in case a base station determines to update an AI/ML model, the base station may update the AI/ML model by newly performing AI/ML model training based on data related to the AI/ML model. In addition, the base station may share the updated AI/ML model with terminals.

As another example, MPF may include a value for data that affects model performance evaluation. Herein, the value for the data that affects the model performance evaluation may be information on data directly affecting performance among data affecting performance results. As an example, a value for data affecting model performance evaluation may include at least any one of information on a parameter and a value for the data. In addition, in consideration of the value for the data, only a quantized value or a differential value may be included but not be limited to a specific embodiment. Herein, the value for the data affecting the model performance evaluation may not include information on a specific model. As an example, for existing data that is being transmitted, a value for data affecting model performance evaluation may include only information on the data. As another example, for data that has not been periodically reported, a value for data affecting model performance evaluation may be transmitted together with a value for the data but is not limited to a specific embodiment.

In addition, as an example, information included in MPF may be transmitted based on a scheme based on Table 6 below.

TABLE 6
be transmitted in PHY control information through PUCCH/PUSCH
be transmitted in MAC control information through Uplink Shared
Channel (UL-SCH) through new MAC CE definition
be transmitted in RRC control information through UL-DCCH through
new RRC message or IE definition

Specifically, information included in MPF per AI/ML model is transmitted, a terminal may perform transmission using physical (PHY) control information through at least any one of a physical uplink control channel (PUCCH) and a physical uplink shared channel (PUSCH). Herein, information included in MPF per AI/ML model is transmitted, specific resources corresponding to corresponding AI/ML models may be periodically allocated. Herein, at least any one of a PUCCH resource and a PUSCH resource may be indicated through a terminal-specific (UE-specific) message for each terminal or each AI/ML model. As an example, in case MPF indicates “bad performance” by 1 bit, information included in the MPF may be transmitted through a physical control channel but may not be limited thereto.

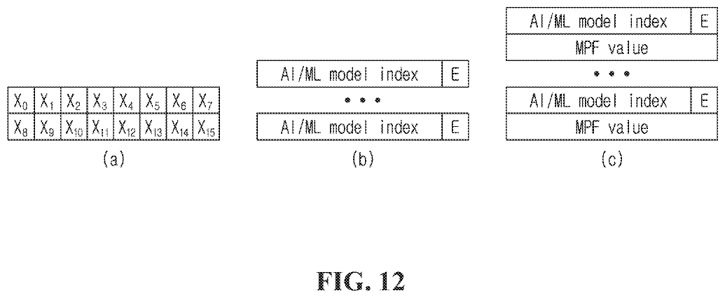

In addition, as an example, medium access control (MAC) information, which is information included in MPF, may be transmitted through a UL-SCH through a new MAC control element (CE). As an example, MPF transmission per AI/ML model may not require fast transmission. For information requiring fast report, periodical transmission of a physical resource may be advantageous in supporting periodical transmission or immediate transmission of information as necessary. However, in case no fast report is required, information included in MPF may be transmitted to a base station through a resource request if the MPF is generated using an MAC CE. As an example, FIG. 12 may be an MAC CE format in which information included in MPF applicable to the present disclosure is transmitted.

Specifically, referring to FIG. 12, (a) of FIG. 12 may be a format of a case in which a maximum of 16 AI/ML models are configured. Herein, MPF may be a 1-bit indicator indicating whether or not performance is bad in comparison with a preset value, and each field may correspond to 1-bit indication information. As an example, an AI/ML model, which is set by a first value, may indicate that performance is evaluated to be equal to or less than a specific reference value, but may not be limited thereto. In addition, as an example, (b) of FIG. 12 may indicate bad evaluation of AI/ML model performance to a base station by indicating a model index instead of bitmap-type transmission. Herein, an E field may be used to indicate whether or not there is additional model index information following 1-byte information.

As another example, (c) of FIG. 12 may be a format that is used to transmit an MPF value for each AI/ML model together. Herein, along with model index information, a performance result value for a corresponding AI/ML model may be included and transmitted. Herein, based on a specific AI/ML model and a performance result value, whether or not there is additional information may be indicated through the E field but may not be limited to a specific embodiment.

As another example, information included in MPF as RRC control information may be transmitted through an uplink dedicated control element (DCCH) based on a new RRC message or an information element (IE). Specifically, a new RRC message or a new IE may include at least any one of a model index and an MPF value. As an example, in case a large amount of information needs to be transmitted or frequent transmission is not required, a RRC message, which is not sensitive to delay, may be needed but not be limited thereto.

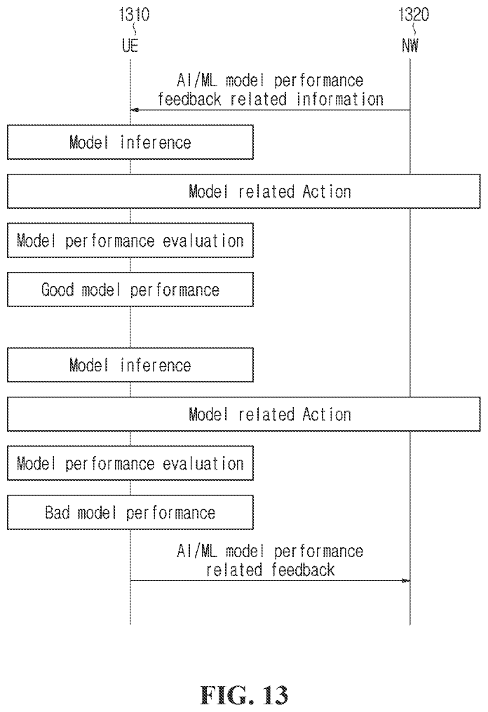

As another example, FIG. 13 is a view illustrating an operation of a terminal that is applicable to the present disclosure. Referring to FIG. 13, a terminal 1310 may receive MPF-related configuration information while receiving an AI/ML model. In addition, as an example, the terminal 1310 may receive MPF-related configuration information after receiving an AI/ML model. Herein, MPF-related information may include at least any one of resource information for transmitting the MPF by the terminal 1310, index information for an AI/ML model, and event information for transmitting feedback. Then, the terminal 1310 may perform model inference and perform an action based on the model inference. That is, the terminal 1310 may perform an operation for a specific procedure or function based on an output value derived by the model information and perform an action based on a corresponding output. Herein, the action may be an operation based on communication between the terminal 1310 and a network 1320 and not be limited to a specific form. Then, the terminal 1310 may perform performance evaluation for the AI/ML model by a result of the action that is performed according to the model inference. Herein, the terminal 1310 may determine whether or not the AI/ML model performance satisfies a reference value (or threshold), based on event information that is configured through AI/ML model-related information. As an example, in case the AI/ML model performance satisfies the reference value and the performance is determined to be good, the terminal 1310 may not transmit MPF information to the network 1320.

On the other hand, in case the AI/ML model performance does not satisfy the reference value (or threshold) and the performance is determined to be bad, the terminal 1310 may transmit MPF to the network 1320 based on the AI/ML model-related information.

Herein, as an example, detailed parameters for MPF may be as shown in Table 7 below. However, this is merely one example but is not limited to the above-described embodiment. Specifically, prediction accuracy for each AI/ML model may be set as a parameter for MPF. Herein, prediction accuracy may be AI/ML model-specific prediction accuracy. As an example, prediction accuracy may include a value for at least any one of beam prediction, trajectory prediction, load prediction, CSI prediction, location prediction, and other prediction, but may not be limited to a specific form. As another example, CSI feedback (e.g., CQI, CRI/SSBRI+RSRP, PMI) may be set as a parameter for MPF. As another example, measured values (e.g., RSRP/RSRQ/SINR for a cell or SSB/CSI-RS) may be set as a parameter for MPF but are not limited to a specific embodiment.

TABLE 7
Prediction accuracy for each model
CSI feedback(e.g., CQI, CRI/SSBRI + RSRP, PMI)
Measurement results(e.g., RSRP/RSRQ/SINR for a cell or SSB/CSI-RS)

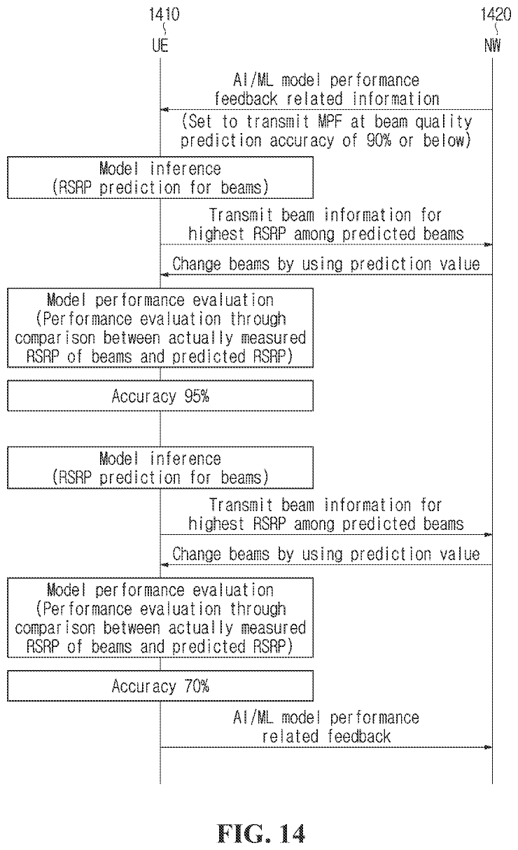

Herein, as an example, FIG. 14 is a view illustrating an operation of a terminal based on beam prediction that is applicable to the present disclosure. Referring to FIG. 14, a terminal 1410 may receive AI/ML model MPF-related information from a network 1420 together with an AI/ML model or after receiving the AI/ML model, and this is the same as described above. Herein, MPF-related information for the AI/ML model may include information on beam quality prediction accuracy. As an example, through an AI/ML model MPF-related message, the network 1420 may set the terminal 1410 to transmit MPF only at beam prediction accuracy of 90% or below based on a beam prediction model, but may not be limited thereto.

Then, the terminal 1410 may derive predicted reference signal received power (RSRP) for beams according to the received AI/ML model as an output. Based on output information, the terminal 1410 may notify information on a beam(s) with highest RSRP to the network 1420. Then, the network 1420 may perform beam change by using a prediction value. That is, the terminal 1410 and the network 1420 may perform an action based on model inference.

Then, the terminal 1410 may evaluate performance of the AI/ML model through comparison between actually measured RSRP for actual beams and previously predicted RSRP at a time of beam change. As an example, in case the prediction accuracy is equal to or higher than 90%, the terminal 1410 may perform next model inference by using the AI/ML model without transmitting MPF. That is, a preset value (or threshold) may be 90%. On the other hand, in case a model performance evaluation result is an accuracy of 90% or below, the terminal 1410 may transmit MPF on the AI/ML model to the network 1420. Then, the network 1420 may update the AI/ML model based on the received MPF and provide information on the updated AI/ML model to the terminal 1410.

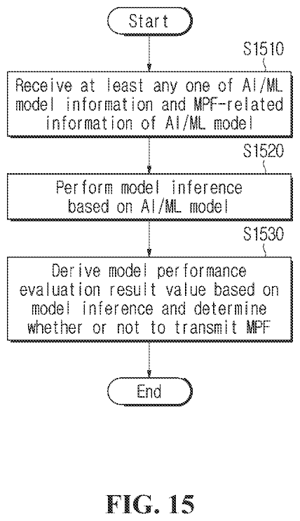

FIG. 15 is a flowchart illustrating an operation of a terminal that is applicable to the present disclosure.

Referring to FIG. 15, the terminal may receive at least any one of AI/ML model information and MPF-related information of an AI/ML model (S1510). As an example, the terminal may obtain the MPF-related information of the AI/ML model after receiving the AI/ML model information. As another example, the terminal may obtain the MPF-related information together with the AI/ML model information, and this is the same as described above. Next, the terminal may perform model information based on the AI/ML model (S1520). Next, the terminal may derive a model performance evaluation result value based on the model inference and thus determine whether or not to transmit MPF (S1530). Herein, the MPF-related information may include at least any one of MPF parameter information of the AI/ML model. MPF triggering condition information, and MPF-related data information. As an example, an MPF parameter may be identically set in at least one or more AI/ML models or may be differently set in each AI/ML model, and this is the same as described above. In addition, as an example, the MPF parameter information may include at least any one of prediction accuracy information of the AI/ML model, CSI feedback information, and information on measured values.

Herein, as a concrete example, in case beam prediction is performed based on an AI/ML model, the terminal may obtain beam quality prediction accuracy information included in MPF parameter information. Herein, the beam quality prediction accuracy information may include a preset beam quality prediction accuracy value for determining whether or not to transmit MPF to a base station. Next, the terminal may perform RSRP prediction for at least one or more beams through model inference based on the AI/ML model and report a beam with highest RSRP to the base station. Next, the base station may change beams. That is, the terminal and the base station may perform an action based on the model inference. Herein, for a model performance evaluation result value, the terminal may compare actually measured RSRP for at least one or more beams and RSRP prediction for at least one or more beams. Herein, based on whether or not the above-described value is greater than or equal to the beam quality prediction accuracy value, the terminal may determine whether or not to transmit MPF to the base station.

As another example, the above-described MPF triggering condition information may include at least any one of threshold information and transmission scheme information. Herein, the threshold information may include at least any one of a threshold for a feedback value and a threshold related to update determination of an AI/ML model. In addition, the transmission scheme information may indicate an MPF transmission scheme of an AI/ML model, and MPF may be transmitted based on at least any one of periodic transmission, aperiodic transmission based on an event, and transmission on a model inference occasion. In addition, the terminal may perform an action based on an output for model inference of AI/ML model information and perform model performance evaluation based on the output and the action. Herein, in case the terminal determines not to transmit MPF of the AI/ML model based on the model performance evaluation, the terminal may generate an output based on model inference of the AI/ML model and perform an action. On the other hand, in case the terminal determines to transmit MPF of the AI/ML model based on the model performance evaluation, the terminal may receive updated AI/ML model information from the base station, and generate an output based on the updated AI/ML model and perform an action. That is, the terminal may perform model inference through the updated AI/ML model.

In addition, as an example, whether or not to transmit MPF of an AI/ML model may be determined based on at least any one of an event set by the base station, an event set by the terminal, and a preset event.

In addition, in case it is determined that MPF is to be transmitted, the MPF may include at least any one of 1-bit indication information indicating performance status of each AI/ML model, a model performance evaluation result value of an AI/ML model, and a data value related to model performance evaluation. Herein, in case the MPF includes the 1-bit indication information indicating performance status of each AI/ML model, the 1-bit indication information indicating performance status of each AI/ML model may be determined based on comparison between a model performance evaluation result value based on model inference and a threshold and be included in the MPF. In addition, in case the MPF includes the model performance evaluation result value of each AI/ML model, the MPF may include at least any one of the model performance evaluation result value and a value of difference between the model performance evaluation result value and a preset value.

In addition, as an example, in case it is determined that MPF of an AI/ML model is to be transmitted to the base station, the MPF may be indicated through at least any one of a PUCCH and a PUSCH. As another example, in case it is determined that MPF of an AI/ML model is to be transmitted to the base station, the MPF may be transmitted by being included in an MAC CE. As another example, in case it is determined that MPF of an AI/ML model is to be transmitted to the base station, the MPF may be transmitted through an uplink-dedicated control channel based on a RRC message.

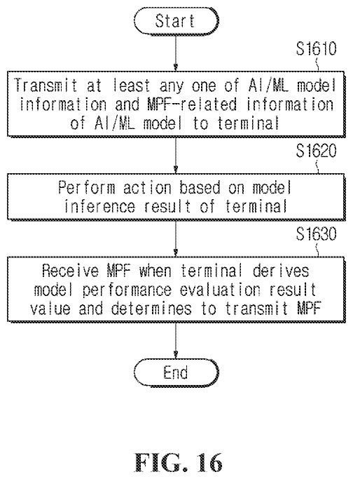

FIG. 16 is a flowchart illustrating an operation of a terminal that is applicable to the present disclosure.

Referring to FIG. 16, a base station may transmit at least any one of AI/ML model information and MPF-related information of an AI/ML model (S1610). As an example, the base station may additionally transmit the MPF-related information of the AI/ML model after transmitting the AI/ML model information. As another example, the base station may transmit the MPF-related information of the AI/ML model together with the AI/ML model information, and this is the same as described above. Next, the base station may perform an action based on a model inference result of a terminal (S1620). Next, the terminal may derive a model performance evaluation result value based on model inference and thus determine whether or not to transmit MPF. As an example, in case the terminal derives the model performance evaluation result value and determines to transmit the MPF, the base station may receive the MPF from the terminal (S1630). Herein, the MPF-related information may include at least any one of MPF parameter information of the AI/ML model, MPF triggering condition information, and MPF-related data information. As an example, an MPF parameter may be identically set in at least one or more AI/ML models or may be differently set in each AI/ML model, and this is the same as described above. In addition, as an example, the MPF parameter information may include at least any one of prediction accuracy information of the AI/ML model. CSI feedback information, and information on measured values.

Herein, as a concrete example, in case beam prediction is performed based on an AI/ML model, the terminal may obtain beam quality prediction accuracy information included in MPF parameter information from the base station. Herein, the beam quality prediction accuracy information may include a preset beam quality prediction accuracy value for determining whether or not to transmit MPF to a base station. Next, the terminal may perform RSRP prediction for at least one or more beams through model inference based on the AI/ML model and report a beam with highest RSRP to the base station. Next, the base station may change beams. That is, the terminal and the base station may perform an action based on the model inference. Herein, for a model performance evaluation result value, the terminal may compare actually measured RSRP for at least one or more beams and RSRP prediction for at least one or more beams. Herein, based on whether or not the above-described value is greater than or equal to the beam quality prediction accuracy value, the terminal may determine whether or not to transmit MPF to the base station.

As another example, the above-described MPF triggering condition information may include at least any one of threshold information and transmission scheme information. Herein, the threshold information may include at least any one of a threshold for a feedback value and a threshold related to update determination of an AI/ML model. In addition, the transmission scheme information may indicate an MPF transmission scheme of an AI/ML model, and MPF may be transmitted based on at least any one of periodic transmission, aperiodic transmission based on an event, and transmission on a model inference occasion. In addition, the terminal may perform an action based on an output for model inference of AI/ML model information and perform model performance evaluation based on the output and the action. Herein, in case the terminal determines not to transmit MPF of the AI/ML model based on the model performance evaluation, the terminal may generate an output based on model inference of the AI/ML model and perform an action. On the other hand, in case the terminal determines to transmit MPF of the AI/ML model based on the model performance evaluation, the terminal may receive updated AI/ML model information from the base station, and generate an output based on the updated AI/ML model and perform an action. That is, the terminal may perform model inference through the updated AI/ML model.

In addition, as an example, whether or not to transmit MPF of an AI/ML model may be determined based on at least any one of an event set by the base station, an event set by the terminal, and a preset event.

In addition, in case it is determined that MPF is to be transmitted, the MPF may include at least any one of 1-bit indication information indicating performance status of each AI/ML model, a model performance evaluation result value of an AI/ML model, and a data value related to model performance evaluation. Herein, in case the MPF includes the 1-bit indication information indicating performance status of each AI/ML model, the 1-bit indication information indicating performance status of each AI/ML model may be determined based on comparison between a model performance evaluation result value based on model inference and a threshold and be included in the MPF. In addition, in case the MPF includes the model performance evaluation result value of each AI/ML model, the MPF may include at least any one of the model performance evaluation result value and a value of difference between the model performance evaluation result value and a preset value.

In addition, as an example, in case it is determined that MPF of an AI/ML model is to be transmitted to the base station, the MPF may be indicated through at least any one of a PUCCH and a PUSCH. As another example, in case it is determined that MPF of an AI/ML model is to be transmitted to the base station, the MPF may be transmitted by being included in an MAC CE. As another example, in case it is determined that MPF of an AI/ML model is to be transmitted to the base station, the MPF may be transmitted through an uplink-dedicated control channel based on a RRC message.

As the examples of the proposal method described above may also be included in one of the implementation methods of the present disclosure, it is an obvious fact that they may be considered as a type of proposal methods. In addition, the proposal methods described above may be implemented individually or in a combination (or merger) of some of them. A rule may be defined so that information on whether or not to apply the proposal methods (or information on the rules of the proposal methods) is notified from a base station to a terminal through a predefined signal (e.g., a physical layer signal or an upper layer signal).

The present disclosure may be embodied in other specific forms without departing from the technical ideas and essential features described in the present disclosure. Therefore, the above detailed description should not be construed as limiting in all respects and should be considered as an illustrative one. The scope of the present disclosure should be determined by rational interpretation of the appended claims, and all changes within the equivalent scope of the present disclosure are included in the scope of the present disclosure. In addition, claims having no explicit citation relationship in the claims may be combined to form an embodiment or to be included as a new claim by amendment after filing.

### INDUSTRIAL APPLICABILITY

The embodiments of the present disclosure are applicable to various radio access systems. Examples of the various radio access systems include a 3^{rd} generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method performed by a terminal in a wireless communication system, the method comprising:
receiving, by the terminal, a synchronization signal from a base station;
transmitting a random access preamble to the base station based on the synchronization signal;
receiving a random access response based on the random access preamble;
performing connection with the base station after receiving the random access response;
receiving at least any one of artificial intelligence (AI)/machine learning (ML) model information and model performance feedback (MPF)-related information for an AI/ML model from the base station; and
performing model inference in the AI/ML model based on the AI/ML model information and determining, through model performance evaluation, whether or not to transmit MPF of the AI/ML model to the base station.

2. The method of claim 1, wherein the MPF-related information includes at least any one of MPF parameter information of the AI/ML model, MPF triggering condition information, and MPF-related data information.

3. The method of claim 2, wherein a MPF parameter is identically set in at least one or more AI/ML models.

4. The method of claim 2, wherein the MPF parameter information includes at least any one of prediction accuracy information of the AI/ML model, channel state information (CSI) feedback information, and information on measured values.

5. The method of claim 4, wherein based on beam prediction being performed based on the AI/ML model, the terminal obtains beam quality prediction accuracy information included in the MPF parameter information,
wherein the beam quality prediction accuracy information includes a preset beam quality prediction accuracy value for determining whether or not to transmit the MPF to the base station,
wherein the terminal performs RSRP prediction for at least one or more beams through the model inference based on the AI/ML model and reports a beam with a highest RSRP to the base station to change a beam, and
wherein the terminal determines whether or not to transmit the MPF to the base station based on whether or not a comparison value between an actually measured RSRP for at least one or more beams and the RSRP prediction for the at least one or more beams is greater or equal to the beam quality prediction accuracy value.

6. The method of claim 2, wherein the MPF triggering condition information includes at least any one of threshold information and transmission scheme information,
wherein the threshold information includes at least any one of a threshold for a feedback value and a threshold regarding update determination of the AI/ML model, and
wherein the transmission scheme information indicates the MPF transmission scheme of the AI/ML model, and the MPF is transmitted based on at least any one of periodic transmission, aperiodic transmission based on an event, and transmission on a model inference occasion.

7. The method of claim 1, wherein the terminal performs an action based on an output for the model inference of the AI/ML model information and performs the model performance evaluation based on the output and the action,
wherein based on the MPF of the AI/ML model being not to be transmitted based on the model performance evaluation, the terminal performs an action by generating an output based on the model inference of the AI/ML model, and
wherein based on the MPF of the AI/ML model being to be transmitted based on the model performance evaluation, the terminal receives the AI/ML model information that is updated in the base station and performs an action by generating an output based on the updated AI/ML model.

8. The method of claim 7, wherein whether or not to transmit the MPF of the AI/ML model is determined based on at least any one of an event set by the base station, an event set by the terminal, and a preset event.

9. The method of claim 8, wherein based on transmission of MPF is determined, the MPF includes at least any one of 1-bit indication information indicating a performance status of each of the AI/ML model, a model performance evaluation result value of the AI/ML model, and a data value associated with model performance evaluation.

10. The method of claim 9, wherein based on the MPF including the 1-bit indication information indicating the performance status of the each of the AI/ML model, the 1-bit indication information indicating the performance status of the each of the AI/ML model is determined based on comparison between the model performance evaluation result value based on the model inference and a threshold and is included in the MPF.

11. The method of claim 9, wherein based on the MPF including the model performance evaluation result value of the each of the AI/ML model, the MPF includes at least any one of the model performance evaluation result value and a difference value between the model performance evaluation result value and a preset value.

12. The method of claim 1, wherein based on the MPF of the AI/ML model being determined to be transmitted to the base station, the MPF is indicated through at least any one of a physical uplink control channel (PUCCH) and a physical uplink shared channel (PUSCH).

13. The method of claim 1, wherein based on the MPF of the AI/ML model being determined to be transmitted to the base station, the MPF is transmitted by being included in a medium access control (MAC) control element (CE).

14. The method of claim 1, wherein based on the MPF of the AI/ML model being determined to be transmitted to the base station, the MPF is transmitted through an uplink-dedicated control channel based on a radio resource control (RRC) message.

15. A method performed by a base station in a wireless communication system, the method comprising:
transmitting a synchronization signal to a terminal;
receiving a random access preamble from the terminal based on the synchronization signal;
transmitting a random access response to the terminal based on the random access preamble;
performing connection with the terminal after receiving the random access response; and
transmitting at least any one of artificial intelligence (AI)/machine learning (ML) model information and model performance feedback (MPF)-related information for an AI/ML model to the terminal,
wherein the terminal performs model inference in the AI/ML model based on the AI/ML model information and determines, through model performance evaluation, whether or not to transmit MPF of the AI/ML model to the base station.

16. A terminal in a wireless communication system, the terminal comprising:
a transceiver; and
a processor coupled with the transceiver,
wherein the processor controls the transceiver to:
receive a synchronization signal from a base station,
transmit a random access preamble to the base station based on the synchronization signal, and
receive a random access response based on the random access preamble,
wherein the processor performs connection with the base station after receiving the random access response,
wherein the processor controls the transceiver to receive at least any one of artificial intelligence (AI)/machine learning (ML) model information and model performance feedback (MPF)-related information for an AI/ML model from the base station, and
wherein the processor performs model inference in the AI/ML model based on the AI/ML model information and determines, through model performance evaluation, whether or not to transmit MPF of the AI/ML model to the base station.

17-19. (canceled)
